(19) United States
(12) Patent Application Publication
(10) Pub. No.: US 2008/0120286 A1
(43) Pub. Date: May 22, 2008

(54) METHOD AND SYSTEM FOR PERFORMING A CLEAN OPERATION ON A QUERY RESULT

(76) Inventors: Richard D. Dettinger, Rochester, MN (US); Frederick A. Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/562,590

(22) Filed: Nov. 22, 2006

(51) Int. Cl. G06F 17/30

(52) U.S. Cl. 707/5; 707/E17.017

(57) ABSTRACT

A method, system and article of manufacture for performing a clean operation on a query result. One embodiment comprises receiving a query result for an abstract query composed on the basis of a data abstraction model that models physical data in one or more databases in a manner making a schema of the physical data transparent to a user of the abstraction model. The query result has result data that is based on the physical data for at least one logical result field included in the abstract query. The logical result field has a corresponding logical field definition in the abstraction model. One or more value constraints specified in the logical field definition are applied to determine whether the result data of the query result includes invalid data that does not satisfy the value constraints. If so, a data structure is created that uniquely identifies the invalid data.

### BACKGROUND OF THE INVENTION

1. Field of the Invention

The present invention generally relates to data processing and, more particularly, to processing of query results.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) and application programming interfaces (API's) such as Java® Database Connectivity (JDBC). The term “query” denominates a set of commands for retrieving data from a stored database. Queries take the form of a command language, such as SQL, that lets programmers and programs select, insert, update, find out the location of data, and so forth.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity.

Unfortunately, a given database may contain invalid data that can be returned in a given query result, such as negative age values. The invalid data can be introduced into a given database due to various reasons, such as typographical errors, architectural problems with data replication and timing, and mistakes in original data acquisition. Because of the invalid data, the given query result can be useless to a corresponding requesting entity that wants to further process the query result. For instance, if a researcher wants to determine an average age of patients in a hospital for which a specific treatment is suitable and the query result includes negative age values, an incorrect average value is obtained. Accordingly, some level of data cleansing is needed to ensure data consistency and accuracy in the given database.

However, especially in large databases data cleansing is an expensive and time-consuming process that may require a large amount of processor resources and an even larger amount of manpower. Accordingly, data cleansing is not automatically implemented and/or frequently performed in database environments and, as a result, corresponding databases may include invalid data. Thus, a user needs to perform a manual clean operation on each query result obtained from such a database in order to identify invalid data included therewith prior to further processing of the query result. More specifically, the user needs to perform an exhaustive examination on any data returned from the database in order to verify whether the data is valid or to execute suitable database queries that are configured to identify whether the database includes the invalid data.

Therefore, there is a need for an efficient technique for performing a clean operation on a query result.

### SUMMARY OF THE INVENTION

The present invention is generally directed to a method, system and article of manufacture for data processing and, more particularly, for processing of query results obtained in response to execution of abstract queries against underlying databases.

One embodiment provides a computer-implemented method of performing a clean operation on a query result. The method comprises receiving a query result for an abstract query composed on the basis of a data abstraction model. The query result has result data for at least one logical result field included in the abstract query, wherein the query result is based on physical data from one or more databases. The data abstraction model models the physical data in the one or more databases in a manner making a schema of the physical data transparent to a user of the abstraction model. The logical result field has a corresponding logical field definition in the abstraction model. The method further comprises applying one or more value constraints specified in the logical field definition to determine whether the result data of the query result includes invalid data that does not satisfy the value constraints. If so, a data structure is created that uniquely identifies the invalid data.

Another embodiment provides a computer-readable medium containing a program which, when executed by a processor, performs a process for performing a clean operation on a query result. The process comprises receiving a query result for an abstract query composed on the basis of a data abstraction model, wherein the query result has result data for at least one logical result field included in the abstract query. The query result is based on physical data from one or more databases. The data abstraction model models the physical data in the one or more databases in a manner making a schema of the physical data transparent to a user of the abstraction model. The logical result field has a corresponding logical field definition in the abstraction model. The process further comprises applying one or more value constraints specified in the logical field definition to determine whether the result data of the query result includes invalid data that does not satisfy the value constraints. If so, a data structure is created that uniquely identifies the invalid data.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a computer system that may be used in accordance with the invention;

FIG. 2 is a relational view of software components used to create and execute database queries and to process query results, according to one embodiment of the invention;

FIGS. 3A-C are relational views of software components in one embodiment;

FIGS. 4-5 are flow charts illustrating the operation of a runtime component, in one embodiment;

FIG. 6 is a flow chart illustrating a method of processing a query result according to one embodiment of the invention; and

FIG. 7 is an exemplary data structure illustrating data records that are used to identify rows in database tables that include invalid data in one embodiment.

### DETAILED DESCRIPTION OF THE PREFERRED EMBODIMENTS

### Introduction

The present invention is generally directed to a method, system and article of manufacture for data processing and, more particularly, for detecting invalid data included with an underlying database having physical data. In general, invalid data can be included with the underlying database due to various reasons, such as typographical errors, architectural problems with data replication and timing, and mistakes in original data acquisition.

According to one aspect, the physical data in the underlying database is modeled by a data abstraction model defining logical field definitions in a manner making a schema of the physical data transparent to a user of the abstraction model. A given logical field definition can include one or more value constraints on data stored in the underlying database that is associated with the given logical field definition. By applying the value constraint(s) to the stored data, it can be determined whether the stored data that is associated with the given logical field definition is valid. In other words, data that does not satisfy the applied value constraint(s) can be identified as invalid data that can be removed from the underlying database or corrected as appropriate.

In one embodiment, the stored data is retrieved as a query result obtained for an abstract query that is composed on the basis of an underlying data abstraction model associated with the underlying database. The query result has result data for at least one logical result field included in the abstract query. The logical result field has a corresponding logical field definition in the underlying abstraction model that includes one or more suitable value constraints. By applying the suitable value constraint(s) to the query result, it is determined whether the result data of the query result includes invalid data that does not satisfy the suitable value constraint(s). If so, a data structure is created that uniquely identifies the invalid data.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

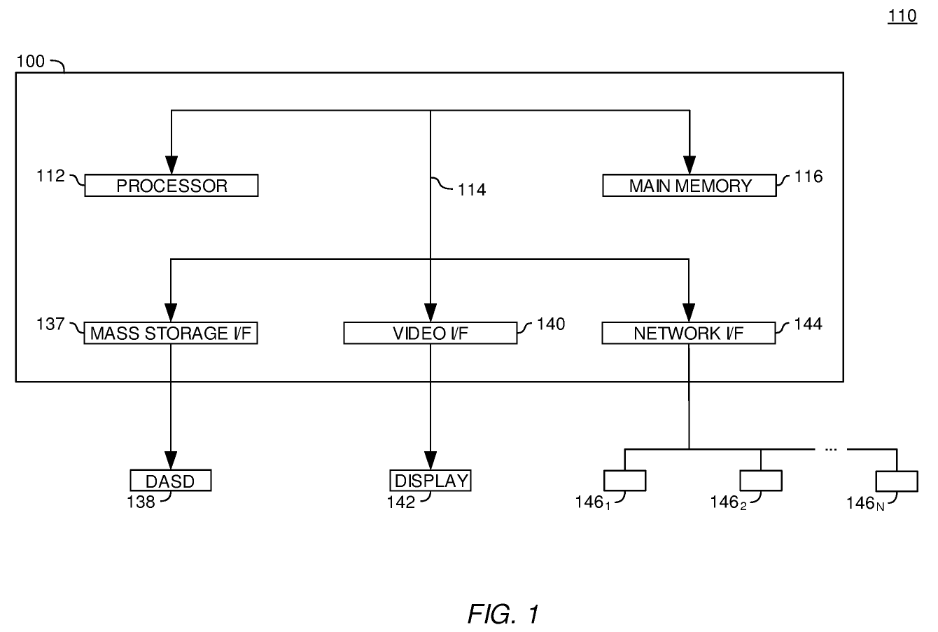

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to a plurality of networked devices 146 (which may be representative of the Internet) via a suitable network. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 116 and storage device 138 could be part of one virtual address space spanning multiple primary and secondary storage devices.

### An Exemplary Query Creation and Execution Environment

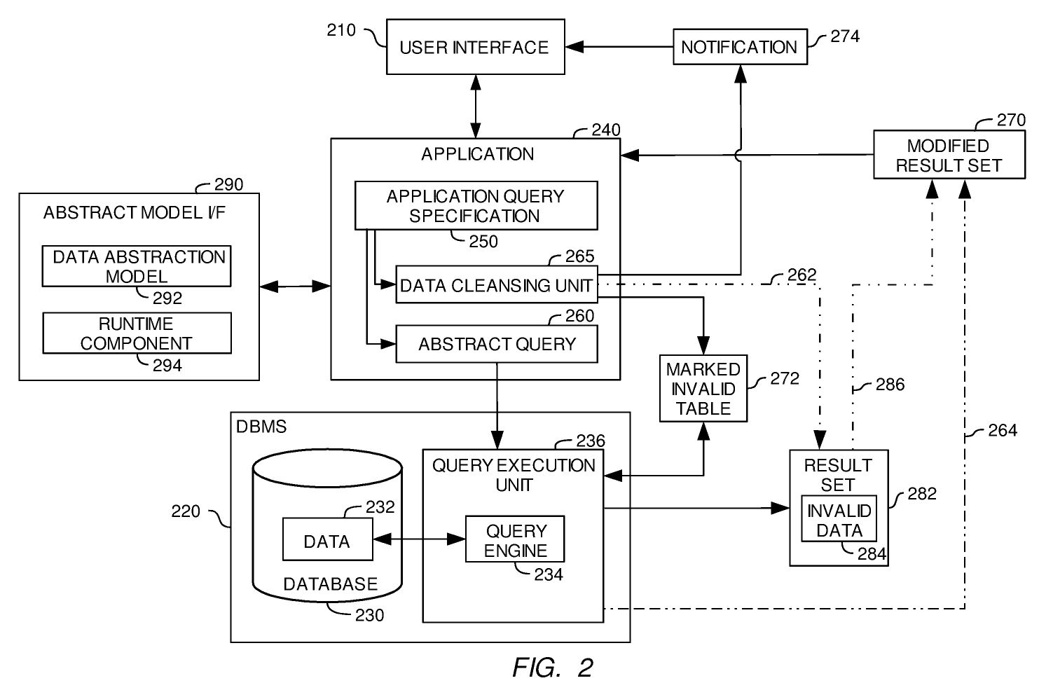

Referring now to FIG. 2, a relational view of software components in one embodiment is illustrated. The software components illustratively include a user interface 210, a DBMS 220, one or more applications 240 (only one application is illustrated for simplicity) and an abstract model interface 290. The abstract model interface 290 illustratively includes a data abstraction model 292 and a runtime component 294. The DBMS 220 illustratively includes a database 230 and a query execution unit 236 having a query engine 234.

The database 230 is shown as a single database having data 232, for simplicity. However, the database 230 can also be implemented by multiple databases which can be distributed relative to one another. Moreover, one or more databases can be distributed to one or more networked devices (e.g., networked devices 146 of FIG. 1). The database 230 is representative of any collection of data regardless of the particular physical representation of the data. A physical representation of data defines an organizational schema of the data. By way of illustration, the database 230 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of the data 232.

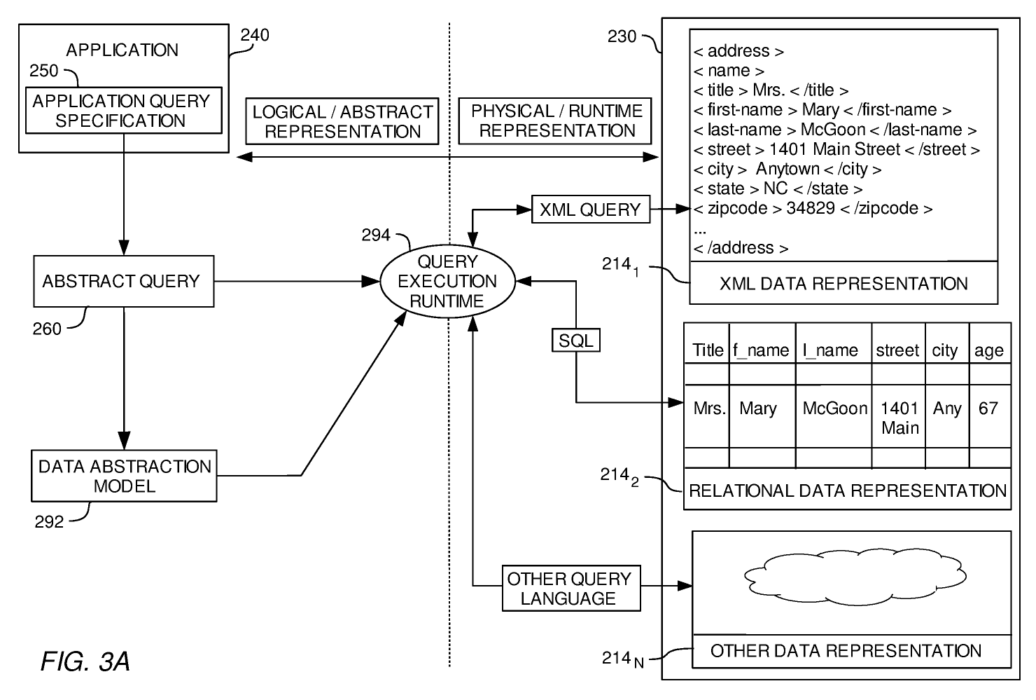

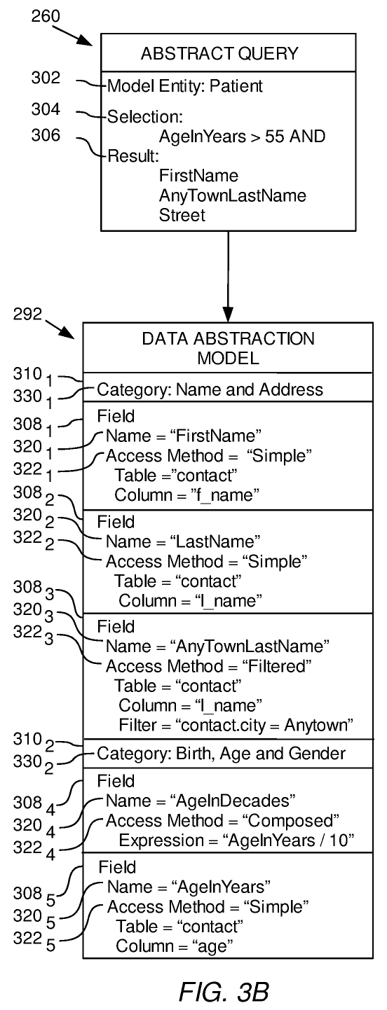

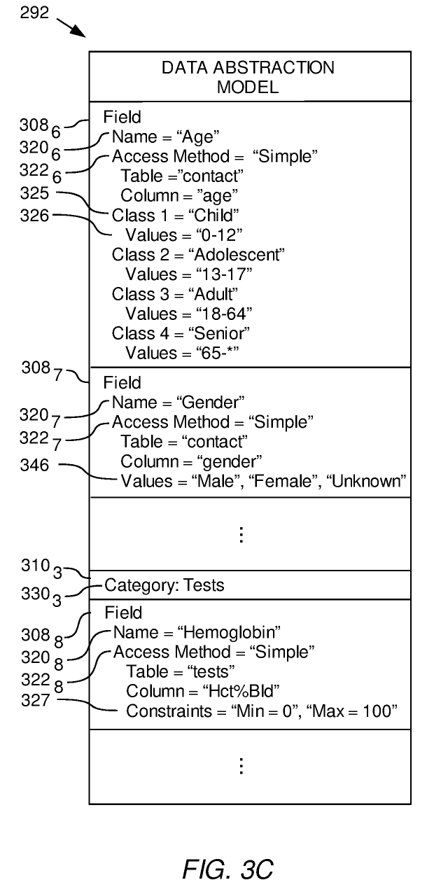

According to one aspect, the application 240 (and more generally, any requesting entity including, at the highest level, users) issues queries against the data 232 in the database 230. In general, the queries issued by the application 240 are defined according to an application query specification 250 and may be predefined (i.e., hard coded as part of the application 240) or generated in response to input (e.g., user input). The application query specification(s) 250 is further described below with reference to FIGS. 3-5.

Illustratively, the queries issued by the application 240 are created by users using the user interface 210, which can be any suitable user interface configured to create/submit queries. According to one aspect, the user interface 210 is a graphical user interface. However, it should be noted that the user interface 210 is only shown by way of example; any suitable requesting entity may create and submit queries against the database 230 (e.g., the application 240, an operating system or an end user). Accordingly, all such implementations are broadly contemplated.

In one embodiment, the requesting entity accesses a suitable database connectivity tool such as a Web application, an Open DataBase Connectivity (ODBC) driver, a Java® DataBase Connectivity (JDBC) driver or a Java® Application Programming Interface (Java® API) for creation of a query. A Web application is an application that is accessible by a Web browser and that provides some function beyond static display of information, for instance by allowing the requesting entity to query the database 230. An ODBC driver is a driver that provides a set of standard application programming interfaces to perform database functions such as connecting to the database 230, performing dynamic SQL functions, and committing or rolling back database transactions. A JDBC driver is a program included with a database management system (e.g., DBMS 220) to support JDBC standard access between the database 230 and Java® applications. A Java® API is a Java®-based interface that allows an application program (e.g., the requesting entity, the ODBC or the JDBC) that is written in a high-level language to use specific data or functions of an operating system or another program (e.g., the application 240).

In one embodiment, the queries issued by the application 240 are composed using the abstract model interface 290. Such queries are referred to herein as “abstract queries”. The abstract model interface 290 is further described below with reference to FIGS. 3-5. The abstract queries are transformed into a form consistent with the physical representation of the data 232 for execution against the database 230.

In the illustrated example, an abstract query 260 is created on the basis of logical fields defined by the data abstraction model 292. More specifically, the abstract query 260 is created by creating a results specification and, if required, selection criteria, as explained in more detail below with reference to FIGS. 3A-C. The results specification is defined by one or more result fields specifying what data elements should be returned from the data 232. The selection criteria is defined using one or more condition fields in corresponding query conditions that are configured to evaluate whether a given element of data should be returned. The result field(s) and the condition field(s) are defined using the logical fields of the data abstraction model 292.

In one embodiment, the abstract query 260 is translated by the runtime component 294 into a concrete (i.e., executable) query, such as an SQL or XML query. The executable query is submitted to the query execution unit 236 for execution. It should be noted that the query execution unit 236 illustratively only includes the query engine 234, for simplicity. However, the query execution unit 236 may include other components, such as a query parser and a query optimizer. A query parser is generally configured to accept a received query input from a requesting entity, such as the application(s) 240, and then parse the received query. The query parser may then forward the parsed query to the query optimizer for optimization. A query optimizer is an application program which is configured to construct a near optimal search strategy (known as an “access plan”) for a given set of search parameters, according to known characteristics of an underlying database (e.g., the database 230), an underlying system on which the search strategy will be executed (e.g., computer system 110 of FIG. 1), and/or optional user specified optimization goals. But not all strategies are equal and various factors may affect the choice of an optimum search strategy. However, in general such search strategies merely determine an optimized use of available hardware/software components to execute respective queries. The query optimizer may then forward the optimized executable query to the query engine 234 for execution. The optimized executable query is then executed by the query engine 234 against the data 232 of the database 230.

In one embodiment, the abstract query 260 is transformed into an executable query, as described above. The executable query is then executed against the data 232 to determine a result set 282 having data for the result fields of the abstract query 260.

The result set 282 is analyzed by a data cleansing unit 265 in order to identify invalid data 284 included therewith. More specifically, the data cleansing unit 265 applies predefined value constraints that are retrieved from the data abstraction model 292 to the result set 282, as indicated by a dashed arrow 262. An exemplary data abstraction model having predefined value constraints is described below with reference to FIGS. 3B-C. Thus, data from the result set 282 that does not satisfy the applied value constraints can be identified. The identified data constitutes the invalid data 284.

It should be noted that the data cleansing unit 265 is merely described by way of example to illustrate a component which is suitable to implement aspects of the invention. In other words, the functions of the data cleansing unit 265 can be implemented into other functional components. For instance, in one embodiment the functions of the data cleansing unit 265 are implemented by the query engine 234 or a component which is implemented separate from the query execution unit 236. All such implementations are broadly contemplated.

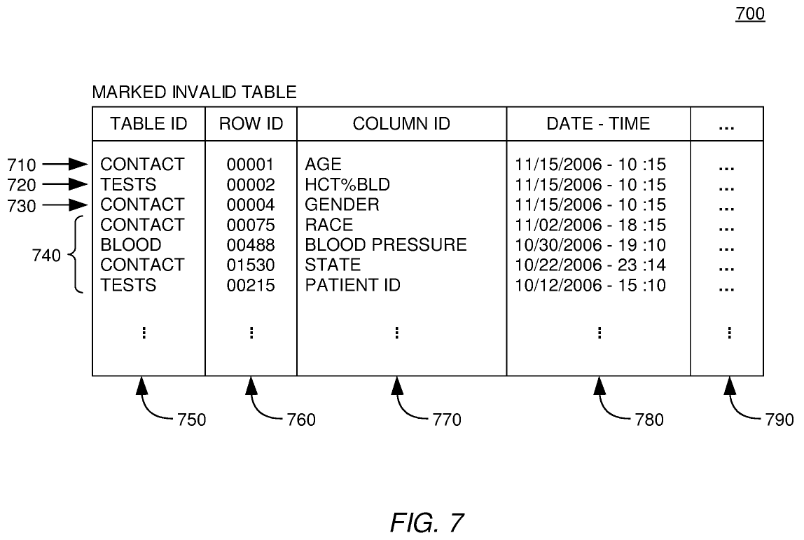

In one embodiment, the data cleansing unit 265 determines from which database tables of the database 230 the invalid data 284 was returned. The data cleansing unit 265 further determines from which rows of the determined database tables the invalid data 284 was retrieved. The data cleansing unit 265 may further determine various other parameters related to the invalid data 284. For instance, columns in the determined database tables having the invalid data 284 and/or date and time of detection of the invalid data 284 can be determined. Then, the data cleansing unit 265 generates a data structure 272 that indicates the determined database tables and rows of the database 230. For simplicity, the data structure 272 is hereinafter referred to as the “marked invalid table” 272. In one embodiment, a separate marked invalid table is generated for each underlying database table having invalid data. An exemplary marked invalid table is described in more detail below with reference to FIG. 7.

In one embodiment, the data cleansing unit 265 modifies the result set 282 on the basis of the identified invalid data 284, whereby the modified result set 270 is generated, as indicated by a dashed arrow 286. For instance, the data cleansing unit removes the invalid data 284 from the result set 282. Alternatively, the data cleansing unit 265 marks up the invalid data 284 in the modified result set 270. By way of example, the invalid data 284 is highlighted or struck through. The modified result set 270 is then output to the application(s) 240 for further processing. For instance, the modified result set 270 is displayed to the user who issued the abstract query 260 user using the user interface 210 or transmitted to a suitable analysis routine.

The data cleaning unit 265 may further send a notification 274 to the user indicating that the result set 282 contains the invalid data 284. In this case, no result set or an empty result set can be returned to the user. The notification 274 can also be transmitted to an administrator of the database 230 together with the marked invalid table 272 requesting the administrator to correct the data 232 in the database 230 on the basis of the marked invalid table 272.

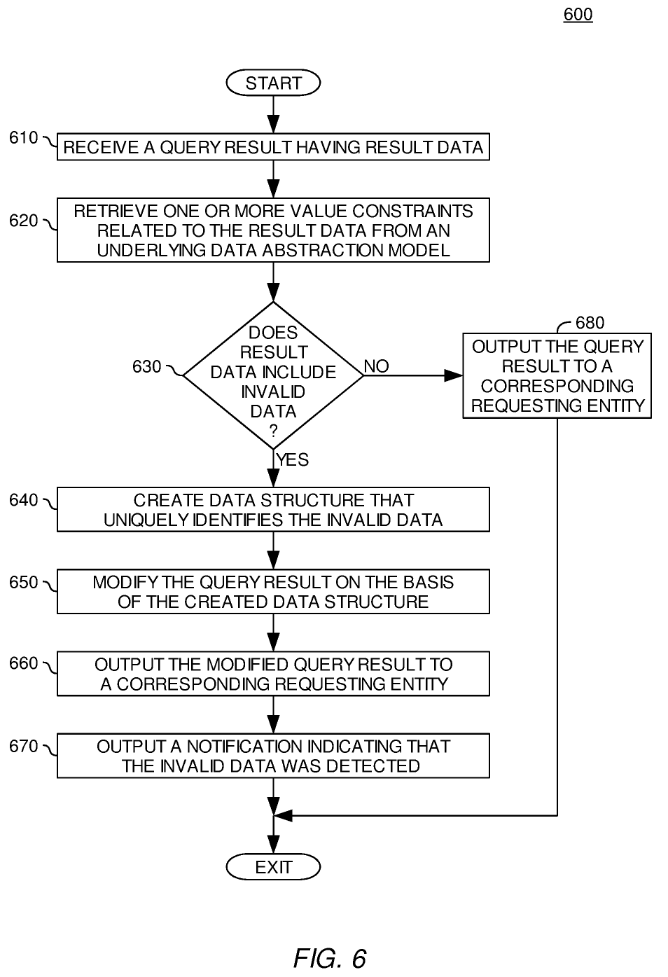

Moreover, the data cleansing unit 265 can mark up rows of database tables in the database 230 that include the invalid data 284. For instance, such rows can be associated with an “invalid” flag. Thus, subsequent queries that are issued against the database 230 can be modified such that rows having an “invalid” flag are no longer returned in corresponding query results. Accordingly, instead of returning the result set 282 having the invalid data 284 in a subsequent execution of the abstract query 260 against the database 230, a suitable modified query retrieves a result set which contains no invalid data (e.g., modified result set 270, as indicated by a dashed arrow 264) and can be returned directly to the application 240 without requiring that a modified result set be created and returned. All such implementations are broadly contemplated. An exemplary method for executing an abstract query against an underlying database and processing a corresponding query result is described below with reference to FIG. 6.

### Logical/Runtime View of Environment

FIGS. 3A-3C show an illustrative relational view of software components in one embodiment. According to one aspect, the software components are configured for query execution management and illustratively include the application 240, the data abstraction model 292, the runtime component 294 and the database 230 of FIG. 2. By way of example, the database 230 includes a plurality of exemplary physical data representations 214₁, 214₂, . . . 214_{N} for the data 232 of FIG. 2.

As noted above with reference to FIG. 2, the application 240 issues the abstract query 260 against the database 230. In one embodiment, the application 240 issues the query 260 as defined by the application query specification 250. The abstract query 260 is composed according to logical fields rather than by direct reference to underlying physical data entities in the database 230. The logical fields are defined by the data abstraction model 292 which generally exposes information as a set of logical fields that may be used within a query (e.g., the abstract query 260) issued by the application 240 to specify criteria for data selection and specify the form of result data returned from a query operation. Furthermore, the abstract query 260 may include a reference to an underlying model entity that specifies the focus for the abstract query 260 (model entity 302). In one embodiment, the application query specification 250 may include both criteria used for data selection (selection criteria 304) and an explicit specification of the fields to be returned (return data specification 306) based on the selection criteria 304, as illustrated in FIG. 3B.

The logical fields of the data abstraction model 292 are defined independently of the underlying data representation (i.e., one of the plurality of exemplary physical data representations 214_{1-N}) being used in the database 230, thereby allowing queries to be formed that are loosely coupled to the underlying data representation. More specifically, a logical field defines an abstract view of data whether as an individual data item or a data structure in the form of, for example, a database table. As a result, abstract queries such as the query 260 may be defined that are independent of the particular underlying data representation used. Such abstract queries can be transformed into a form consistent with the underlying physical data representation 214_{1-N} for execution against the database 230. By way of example, the abstract query 260 is translated by the runtime component 294 into an executable query which is executed against the database 230 to determine a corresponding result set (e.g., result set 282 and/or modified result set 270 of FIG. 2) for the abstract query 260.

In one embodiment, illustrated in FIGS. 3B-C, the data abstraction model 292 comprises a plurality of field specifications 308₁, 308₂, 308₃, 308₄, 308₅, 308₆, 308₇ and 308₈ (eight shown by way of example), collectively referred to as the field specifications 308 (also referred to hereinafter as “field definitions”). Specifically, a field specification is provided for each logical field available for composition of an abstract query. Each field specification may contain one or more attributes. Illustratively, the field specifications 308 include a logical field name attribute 320₁, 320₂, 320₃, 320₄, 320₅, 320₆, 320₇, 320₈ (collectively, field name 320) and an associated access method attribute 322₁, 322₂, 322₃, 322₄, 322₅, 322₆, 322₇, 322₈ (collectively, access methods 322). Each attribute may have a value. For example, logical field name attribute 320₁ has the value “FirstName” and access method attribute 322₁ has the value “Simple”. Furthermore, each attribute may include one or more associated abstract properties. Each abstract property describes a characteristic of a data structure and has an associated value. In the context of the invention, a data structure refers to a part of the underlying physical representation that is defined by one or more physical entities of the data corresponding to the logical field. In particular, an abstract property may represent data location metadata abstractly describing a location of a physical data entity corresponding to the data structure, like a name of a database table or a name of a column in a database table. Illustratively, the access method attribute 322₁ includes data location metadata “Table” and “Column”. Furthermore, data location metadata “Table” has the value “contact” and data location metadata “Column” has the value “f_name”. Accordingly, assuming an underlying relational database schema in the present example, the values of data location metadata “Table” and “Column” point to a table “contact” having a column “f_name”.

In one embodiment, each field specification 308 may contain a definition of one or more value constraints that are suitable to determine whether associated data is valid. By way of example, the field specifications 308₆ to 308₈ include an exemplary classification definition, an exemplary list definition and an exemplary limitation definition, respectively.

Illustratively, the field specification 308₆ includes a classification definition that defines four different value classes “Class 1” to “Class 4” for allowable age values. By way of example, age values from “0” to “12” as defined by a value range parameter 326 are associated with a value class 325 “Class 1” that is referred to as the “Child” class. Age values from “13” to “17” are illustratively associated with the value class “Class 2” that is referred to as the “Adolescent” class, age values from “18” to “64” with the value class “Class 3” that is referred to as the “Adult” class, and age values greater or equal than “65” with the value class “Class 4” that is referred to as the “Senior” class.

The field specification 308₇ illustratively includes a list definition 346 that enumerates allowable values for associated gender data. By way of example, the list definition 346 defines “Male”, “Female” and “Unknown” as allowable values for data that is associated with the “Gender” field 308₇.

The field specification 308₈ illustratively includes a limitation definition 327 that defines an allowable range of values for associated Hemoglobin values. By way of example, the limitation definition 327 defines “0” as minimum allowable value for data that is associated with the “Hemoglobin” field 308₈ and “100” as maximum allowable value.

It should be noted that the illustrated value constraint definitions are merely illustrative and not limiting of the invention. For instance, the illustrated value constraint definitions can be adapted to user- and/or application-specific requirements. By way of example, an upper and a lower limit of normal can be defined by the limitation definition 327 for the Hemoglobin test values. Assume that the lower limit of normal is defined as “11” and the upper limit is defined as “21”. Thus, all Hemoglobin test values of a corresponding query result lying outside the lower and upper limits of normal, thus indicating an abnormal value, could be highlighted when displayed to a user, for example. Accordingly, any possible value constraint definitions are broadly contemplated.

In one embodiment, groups (i.e. two or more) of logical fields may be part of categories. Accordingly, the data abstraction model 292 includes a plurality of category specifications 310₁, 310₂ and 310₃ (two shown by way of example), collectively referred to as the category specifications. In one embodiment, a category specification is provided for each logical grouping of two or more logical fields. For example, logical fields 308₁₋₃, 308₄₋₇ and 308₈ are part of the category specifications 310₁, 310₂ and 310₃, respectively. A category specification is also referred to herein simply as a “category”. The categories are distinguished according to a category name, e.g., category names 330₁, 330₂ and 330₃ (collectively, category name(s) 330). In the present illustration, the logical fields 308₁₋₃ are part of the “Name and Address” category, logical fields 308₄₋₇ are part of the “Birth, Age and Gender” category and logical field 308₈ is part of the “Tests” category.

The access methods 322 generally associate (i.e., map) the logical field names to data in the database (e.g., database 230 of FIG. 2). As illustrated in FIG. 3A, the access methods associate the logical field names to a particular physical data representation 214_{1-N} in the database. By way of illustration, two data representations are shown, an XML data representation 214₁ and a relational data representation 214₂. However, the physical data representation 214_{N} indicates that any other data representation, known or unknown, is contemplated. In one embodiment, a single data abstraction model 292 contains field specifications (with associated access methods) for two or more physical data representations 214_{1-N}. In an alternative embodiment, a different single data abstraction model 292 is provided for each separate physical data representation 214_{1-N}.

Any number of access methods is contemplated depending upon the number of different types of logical fields to be supported. In one embodiment, access methods for simple fields, filtered fields and composed fields are provided. The field specifications 308₁, 308₂ and 308₅₋₈ exemplify simple field access methods 322₁, 322₂, and 322₅₋₈, respectively. Simple fields are mapped directly to a particular entity in the underlying physical representation (e.g., a field mapped to a given database table and column). By way of illustration, as described above, the simple field access method 322₁ shown in FIG. 3B maps the logical field name 320₁ (“FirstName”) to a column named “f_name” in a table named “contact”. The field specification 308₃ exemplifies a filtered field access method 322₃. Filtered fields identify an associated physical entity and provide filters used to define a particular subset of items within the physical representation. An example is provided in FIG. 3B in which the filtered field access method 322₃ maps the logical field name 320₃ (“AnyTownLastName”) to a physical entity in a column named “I_name” in a table named “contact” and defines a filter for individuals in the city of “Anytown”. Another example of a filtered field is a New York ZIP code field that maps to the physical representation of ZIP codes and restricts the data only to those ZIP codes defined for the state of New York. The field specification 308₄ exemplifies a composed field access method 322₄. Composed access methods compute a logical field from one or more physical fields using an expression supplied as part of the access method definition. In this way, information which does not exist in the underlying physical data representation may be computed. In the example illustrated in FIG. 3B the composed field access method 322₄ maps the logical field name 320₄ “AgeInDecades” to “AgeInYears/10”. Another example is a sales tax field that is composed by multiplying a sales price field by a sales tax rate.

It is contemplated that the formats for any given data type (e.g., dates, decimal numbers, etc.) of the underlying data may vary. Accordingly, in one embodiment, the field specifications 308 include a type attribute which reflects the format of the underlying data. However, in another embodiment, the data format of the field specifications 308 is different from the associated underlying physical data, in which case a conversion of the underlying physical data into the format of the logical field is required.

By way of example, the field specifications 308 of the data abstraction model 292 shown in FIG. 3B are representative of logical fields mapped to data represented in the relational data representation 214₂ shown in FIG. 3A. However, other instances of the data abstraction model 292 map logical fields to other physical representations, such as XML.

An illustrative abstract query corresponding to the abstract query 260 shown in FIG. 3B is shown in Table I below. By way of illustration, the illustrative abstract query is defined using XML. However, any other language may be used to advantage.

TABLE I
ABSTRACT QUERY EXAMPLE

| | |
|---|---|
| 001 | <?xml version=“1.0”?> |
| 002 | <!--Query string representation: (AgeInYears > “55”--> |
| 003 | <QueryAbstraction> |
| 004 | <Selection> |
| 005 | <Condition internalID=“4”> |
| 006 | <Condition field=“AgeInYears” operator=“GT” value=“55” |
| 007 | internalID=“1”/> |
| 008 | </Selection> |
| 009 | <Results> |
| 010 | <Field name=“FirstName”/> |
| 011 | <Field name=“AnyTownLastName”/> |
| 012 | <Field name=“Street”/> |
| 013 | </Results> |
| 014 | <Entity name=“Patient” > |
| 015 | <EntityField required=“Hard” > |
| 016 | <FieldRef name=“data://Demographic/Patient ID” /> |
| 017 | <Usage type=“query” /> |
| 018 | </EntityField> |
| 019 | </Entity> |
| 020 | </QueryAbstraction> |

Illustratively, the abstract query shown in Table I includes a selection specification (lines 004-008) containing selection criteria and a results specification (lines 009-013). In one embodiment, a selection criterion consists of a field name (for a logical field), a comparison operator (=, >, <, etc) and a value expression (what is the field being compared to). In one embodiment, a results specification is a list of abstract fields that are to be returned as a result of query execution. A results specification in the abstract query may consist of a field name and sort criteria. The abstract query shown in Table I further includes a model entity specification in lines 014-019 which specifies that the query is a query of the “patient” model entity.

An illustrative data abstraction model (DAM) corresponding to the data abstraction model 292 shown in FIGS. 3B-C is shown in Table II below. By way of illustration, the illustrative Data Abstraction Model is defined using XML. However, any other language may be used to advantage.

TABLE II
DATA ABSTRACTION MODEL EXAMPLE

| | |
|---|---|
| 001 | <?xml version=“1.0”?> |
| 002 | <DataAbstraction> |
| 003 | <Category name=“Name and Address”> |
| 004 | <Field queryable=“Yes” name=“FirstName” displayable=“Yes”> |
| 005 | <AccessMethod> |
| 006 | <Simple columnName=“f_name” tableName=“contact”></Simple> |
| 007 | </AccessMethod> |
| 008 | </Field> |
| 009 | <Field queryable=“Yes” name=“LastName” displayable=“Yes”> |
| 010 | <AccessMethod> |
| 011 | <Simple columnName=“l_name” tableName=“contact”></Simple> |
| 012 | </AccessMethod> |
| 013 | </Field> |
| 014 | <Field queryable=“Yes” name=“AnyTownLastName” displayable=“Yes”> |
| 015 | <AccessMethod> |
| 016 | <Filter columnName=“l_name” tableName=“contact” |
| 017 | Filter=”contact.city=Anytown”> </Filter> |
| 018 | </AccessMethod> |
| 019 | </Field> |
| 020 | </Category> |
| 021 | <Category name=“Birth, Age and Gender”> |
| 022 | <Field queryable=“Yes” name=“AgeInDecades” displayable=“Yes”> |
| 023 | <AccessMethod> |
| 024 | <Composed |
| 025 | Expression=”field:AgeInYears/10”> </Composed> |
| 026 | </AccessMethod> |
| 027 | </Field> |
| 028 | <Field queryable=“Yes” name=“AgelnYears” displayable=“Yes”> |
| 029 | <AccessMethod> |
| 030 | <Simple columnName=“age” tableName=“contact”></Simple> |
| 031 | </AccessMethod> |
| 032 | </Field> |
| 033 | <Field queryable=“Yes” name=“Age” displayable=“Yes”> |
| 034 | <AccessMethod> |
| 035 | <Simple columnName=“age” tableName=“contact”></Simple> |
| 036 | </AccessMethod> |
| 037 | <Class name=”Child”> |
| 038 | <Value min=“0” max=“12” /> |
| 039 | </Class> |
| 040 | <Class name=”Adolescent”> |
| 041 | <Value min=“13” max=“17”/> |
| 042 | </Class> |
| 043 | <Class name=”Adult”> |
| 044 | <Value min=“18” max=“64” /> |
| 045 | </Class> |
| 046 | <Class name=”Senior”> |
| 047 | <Value min=“65”/> |
| 048 | </Class> |
| 049 | </Field> |
| 050 | <Field queryable=“Yes” name=“Gender” displayable=“Yes”> |
| 051 | <AccessMethod> |
| 052 | <Simple columnName=“gender” tableName=“contact”></Simple> |
| 053 | </AccessMethod> |
| 054 | <List> |
| 055 | <Value actualVal=“F” val=“Female” /> |
| 056 | <Value actualVal=“M” val=“Male” /> |
| 057 | <Value actualVal=“U” val=“Unknown” /> |
| 058 | </List> |
| 059 | </Field> |
| 060 | </Category> |
| 061 | <Category name=“Tests”> |
| 062 | <Field queryable=“Yes” name=“Hemoglobin” displayable=“Yes”> |
| 063 | <AccessMethod> |
| 064 | <Simple columnName=“Hct%Bld” tableName=“tests”></Simple> |
| 055 | </AccessMethod> |
| 066 | <Lowerlimit val=“0” /> |
| 067 | <Upperlimit val=“100” /> |
| 068 | </Field> |
| 069 | </Category> |
| 070 | </DataAbstraction> |

By way of example, note that lines 004-008 correspond to the first field specification 308₁ of the DAM 292 shown in FIG. 3B and lines 009-013 correspond to the second field specification 308₂. Note further that lines 033-049 correspond to the field specification 308₆ of the DAM 292 shown in FIG. 3C, wherein lines 037-039 represent the value class definition 325 of the “Child” class with the associated value range parameter 326. Furthermore, lines 050-059 correspond to the field specification 308₇ of the DAM 292 shown in FIG. 3C, wherein lines 054-058 represent the list definition 346, and lines 062-068 correspond to the field specification 308₈ of the DAM 292, wherein lines 066-067 represent the limitation definition 327.

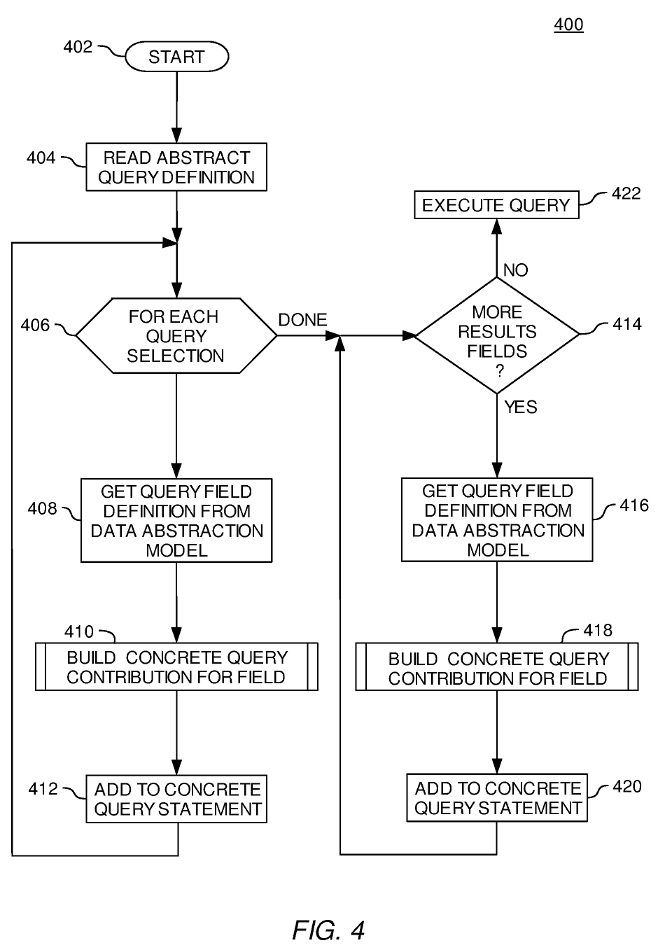

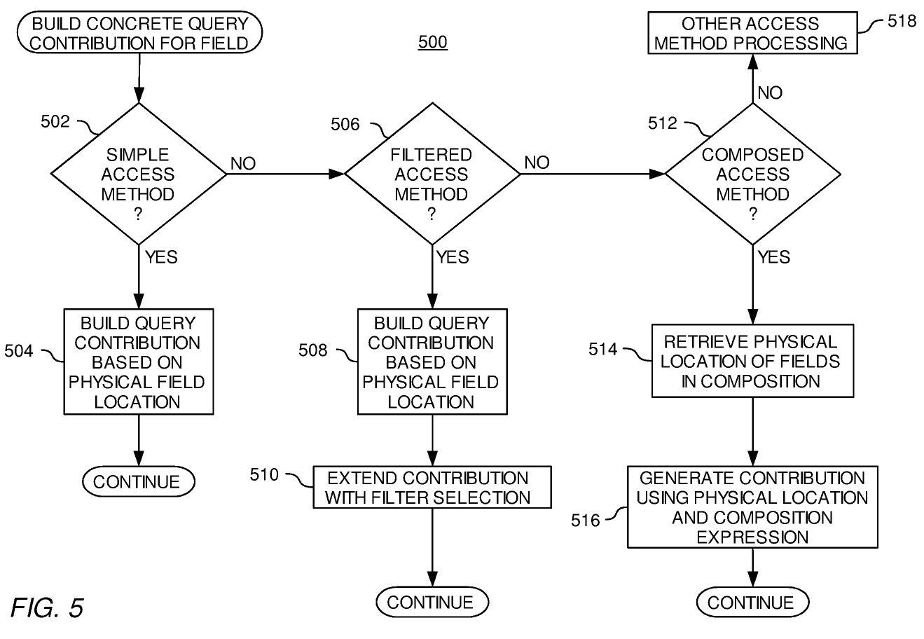

As was noted above, an executable query can be generated on the basis of the abstract query of Table I for execution against an underlying database (e.g., database 230 of FIG. 3A). An exemplary method for generating an executable query on the basis of an abstract query is described below with reference to FIGS. 4-5.

### Generating an Executable Query from an Abstract Query

Referring now to FIG. 4, an illustrative runtime method 400 exemplifying one embodiment of generating an executable query (also referred to hereinafter as “concrete” query) on the basis of an abstract query (e.g., abstract query 260 of FIG. 2) using the runtime component 294 of FIG. 2 is shown. The method 400 is entered at step 402 when the runtime component 294 receives the abstract query (such as the abstract query shown in Table I) as input. At step 404, the runtime component 294 reads and parses the abstract query and locates individual selection criteria (e.g., selection criteria 304 of FIG. 3B) and desired result fields (e.g., return data specification 306 of FIG. 3B).

At step 406, the runtime component 294 enters a loop (defined by steps 406, 408, 410 and 412) for processing each query selection criteria statement present in the abstract query, thereby building a data selection portion of a concrete query. In one embodiment, a selection criterion consists of a field name (for a logical field), a comparison operator (=, >, <, etc) and a value expression (what is the field being compared to). At step 408, the runtime component 294 uses the field name from a selection criterion of the abstract query to look up the definition of the field in the data abstraction model 292. As noted above, the field definition includes a definition of the access method used to access the data structure associated with the field. The runtime component 294 then builds (step 410) a concrete query contribution for the logical field being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from the physical data repository, represented by the database 230 shown in FIG. 2. The concrete query contribution generated for the current field is then added to a concrete query statement (step 412). The method 400 then returns to step 406 to begin processing for the next field of the abstract query. Accordingly, the process entered at step 406 is iterated for each data selection field in the abstract query, thereby contributing additional content to the eventual query to be performed.

In one embodiment, when the loop consisting of steps 406 to 412 was performed for each query selection criteria statement present in the abstract query, the runtime component 294 generates one or more concrete query contributions that are configured to prevent output of invalid data (e.g., invalid data 284 of FIG. 2) in a corresponding result set. Specifically, such concrete query contributions can be configured to prevent output and/or selection of result data from an underlying database table(s) if an “invalid” flag is set with respect to a corresponding row in the underlying database table having the result data. More specifically, such a concrete query contribution can be configured to check for “invalid” flags only in underlying database tables that are identified in an associated marked invalid table (e.g., marked invalid table 272 of FIG. 2). Accordingly, a concrete query contribution can be generated for each database table that is identified in the associated marked invalid table(s). Furthermore, such a concrete query contribution can be configured to verify that row identifiers of rows from the underlying database table(s) that are identified/selected for a corresponding result set (e.g., result set 282 of FIG. 2) are not included with the associated marked invalid table(s). All such embodiments are broadly contemplated.

After building the data selection portion of the concrete query, the runtime component 294 identifies the information to be returned as a result of query execution. As described above, in one embodiment, the abstract query defines a list of result fields, i.e., a list of logical fields that are to be returned as a result of query execution, referred to herein as a results specification. A results specification in the abstract query may consist of a field name and sort criteria. Accordingly, the method 400 enters a loop at step 414 (defined by steps 414, 416, 418 and 420) to add result field definitions to the concrete query being generated. At step 416, the runtime component 294 looks up a result field name (from the result specification of the abstract query) in the data abstraction model 292 and then retrieves a result field definition from the data abstraction model 292 to identify the physical location of data to be returned for the current logical result field. The runtime component 294 then builds (at step 418) a concrete query contribution (of the concrete query that identifies physical location of data to be returned) for the logical result field. At step 420, the concrete query contribution is then added to the concrete query statement. Once each of the result specifications in the abstract query has been processed, processing continues at step 422, where the concrete query is executed.

One embodiment of a method 500 for building a concrete query contribution for a logical field according to steps 410 and 418 is described with reference to FIG. 5. At step 502, the method 500 queries whether the access method associated with the current logical field is a simple access method. If so, the concrete query contribution is built (step 504) based on physical data location information and processing then continues according to method 400 as described above. Otherwise, processing continues to step 506 to query whether the access method associated with the current logical field is a filtered access method. If so, the concrete query contribution is built (step 508) based on physical data location information for a given data structure(s). At step 510, the concrete query contribution is extended with additional logic (filter selection) used to subset data associated with the given data structure(s). Processing then continues according to method 400 described above.

If the access method is not a filtered access method, processing proceeds from step 506 to step 512 where the method 500 queries whether the access method is a composed access method. If the access method is a composed access method, the physical data location for each sub-field reference in the composed field expression is located and retrieved at step 514. At step 516, the physical field location information of the composed field expression is substituted for the logical field references of the composed field expression, whereby the concrete query contribution is generated. Processing then continues according to method 400 described above.

If the access method is not a composed access method, processing proceeds from step 512 to step 518. Step 518 is representative of any other access method types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

### Managing Processing of a Query Result

Referring now to FIG. 6, one embodiment of a method 600 for processing of a query result (e.g., result set 282 of FIG. 2) received from one or more underlying databases (e.g., database 230 of FIG. 2) is illustrated. At least a portion of the steps of method 600 can be performed using the user interface 210 of FIG. 2, the abstract model interface 290 of FIG. 2 and/or the query execution unit 236 of FIG. 2.

Method 600 starts at step 610, where a query result is received. By way of example, assume now that the exemplary query result of Table III below is received.

TABLE III
QUERY RESULT EXAMPLE

| 001 | Patient ID | Age | Gender | Hemoglobin |
|---|---|---|---|---|
| 002 | 1 | −1 | Female | 15.5 |
| 003 | 2 | 25 | Male | 188 |
| 004 | 3 | 65 | Female | 7 |
| 005 | 4 | 78 | Hispanic | 10 |
| 006 | 5 | 6 | Female | 13 |

The exemplary query result of Table III includes four result fields (line 001) having information concerning patients of a given hospital. More specifically, the exemplary query result of Table III illustratively includes data records having patient identifiers (“Patient ID” result field), age (“Age” result field), gender (“Gender” result field) and Hemoglobin test values (“Hemoglobin” result field) of selected patients.

In one embodiment, the exemplary query result of Table III is received in response to execution of an underlying abstract query (e.g., abstract query 260 of FIG. 2) against the underlying database(s). By way of example, assume that the exemplary query result of Table III is obtained from a database table “contact” having information for the “Patient ID”, “Age” and “Gender” result fields, and a database table “tests” having Hemoglobin test values for the “Hemoglobin” result field. In one embodiment, the database tables are identified using a corresponding data abstraction model (e.g., the exemplary data abstraction model of Table II) used for transforming the underlying abstract query into a corresponding concrete query, as described above with reference to FIGS. 4 and 5. An exemplary database table “contact” is shown in Table IV below. The database table “contact” illustrates an example of the data 232 in the database 230 of FIG. 2.

TABLE IV
EXEMPLARY “CONTACT” TABLE

| 001 | RowID | PatientID | Age | Gender | Race | State |
|---|---|---|---|---|---|---|
| 002 | 00001 | 1 | −1 | Female | Hispanic | TX |
| 003 | 00002 | 2 | 25 | Male | Caucasian | NY |
| 004 | 00003 | 3 | 65 | Female | Hispanic | AZ |
| 005 | 00004 | 4 | 78 | Hispanic | Caucasian | NJ |
| 006 | 00005 | 5 | 6 | Female | Asian | MN |

As can be seen from line 001 of Table IV, the “contact” table illustratively contains Patient ID, Age, Gender, Race and State data for each patient. Furthermore, each data record in the exemplary “contact” table of Table IV is uniquely identified by a corresponding row identifier “RowID”.

An exemplary database table “tests” is shown in Table V below. The database table “tests” also illustrates an example of the data 232 in the database 230 of FIG. 2.

TABLE V
EXEMPLARY “TESTS” TABLE

| 001 | RowID | PatientID | Hct % BId |
|---|---|---|---|
| 002 | 00001 | 1 | 15.5 |
| 003 | 00002 | 2 | 188 |
| 004 | 00003 | 3 | 7 |
| 005 | 00004 | 4 | 10 |
| 006 | 00005 | 5 | 13 |

As can be seen from Table V, the “tests” table illustratively contains Hemoglobin test values for patients that are uniquely identified by their corresponding patient identifiers. Furthermore, each data record in the exemplary “tests” table of Table V is uniquely identified by a corresponding row identifier “RowID”.

At step 620, one or more value constraints related to result data in the received query result are retrieved from an underlying data abstraction model (e.g., data abstraction model 294 of FIG. 2). More specifically, the one or more value constraints are retrieved from logical field specifications (e.g., field specifications 308 of FIGS. 3B-C) that correspond to the result fields of the received query result.

Assume now that in the given example the value constraints described above with reference to FIG. 3C and Table II exist for the logical fields that correspond to the “Age”, “Gender” and “Hemoglobin” result fields. Accordingly, the exemplary value constraints of Table VI which are described in natural language, for simplicity, are retrieved for the “Age” result field from lines 037-048 of Table II. Furthermore, the exemplary value constraints of Table VII are retrieved for the “Gender” result field from lines 054-058 of Table II, and the exemplary value constraints of Table VII are retrieved for the “Hemoglobin” result field from lines 066-067 of Table II, both of which are also described in natural language, for simplicity.

TABLE VI
CLASSIFICATION DEFINITION EXAMPLE

| | | |
|---|---|---|
| 001 | Child | 0–12 |
| 002 | Adolescent | 13–17 |
| 003 | Adult | 18–64 |
| 004 | Senior | 65-* |

As noted above with reference to FIG. 3C, allowable age values for the “Child” class are values from “0” to “12” (line 001), for the “Adolescent” class from “13” to “17” (line 002), for the “Adult” class from “18” to “64” (line 003) and for the “Senior” class equal or greater than “65” (line 004).

TABLE VII
LIST DEFINITION EXAMPLE

| | |
|---|---|
| 001 | Male |
| 002 | Female |
| 003 | Unknown |

As noted above with reference to FIG. 3C, allowable gender values are “Male” (line 001), “Female” (line 002) and “Unknown” (line 003).

TABLE VIII
LIMITATION DEFINITION EXAMPLE

| | | |
|---|---|---|
| 001 | Minimum | 0 |
| 002 | Maximum | 100 |

As noted above with reference to FIG. 3C, allowable Hemoglobin values are greater or equal than “0” (line 001) and equal or less than “100” (line 002).

At step 630, it is determined whether the received query result includes invalid data. In one embodiment, the determination is performed during generation of the query result. In other words, when a given data record is identified as result data for the query result, it is determined whether the given data record includes invalid data prior to inserting the given data record into the query result. In the given example, it is determined whether the result data of the exemplary query result of Table III satisfies the exemplary value constraints of Tables VI-VII. If so, the query result does not include invalid data and is output to a corresponding requesting entity at step 680, and processing then exits. Otherwise, processing continues at step 640.

In the given example, it is determined at step 630 that the exemplary query result of Table III includes invalid data. More specifically, it is determined at step 630 that the age value “−1” in line 002 of the exemplary query result of Table III does not satisfy the exemplary classification definition of Table VI, which does not allow negative age values. Furthermore, the Hemoglobin test value “188” in line 003 of the exemplary query result of Table III does not satisfy the exemplary limitation definition of Table VII, as it is greater than the allowed maximum of “100”. Finally, the gender “Hispanic” in line 005 of the exemplary query result of Table III does not satisfy the exemplary list definition of Table VII, as it is not an allowed gender value.

At step 640, a data structure (e.g., invalid marked table 272 of FIG. 2) that uniquely identifies the invalid data in the underlying database table(s) is created on the basis of each identified data record and result field in the received query result that include the invalid data. The data structure uniquely identifies at least each row in a corresponding table of the one or more underlying databases that includes the invalid data. Assume now that in the given example the exemplary data structure of Table IX below is created, which is hereinafter also referred to as the “marked invalid table”. By way of example, the exemplary data structure is illustrated in tabular form.

TABLE IX
EXEMPLARY MARKED INVALID TABLE

| 001 | Table ID | RowID |
|---|---|---|
| 002 | contact | 00001 |
| 003 | tests | 00002 |
| 004 | contact | 00004 |

As can be seen from Table IX, rows 00001 (line 002) and 00004 (line 004) of the exemplary “contact” table of Table IV and row 00002 (line 003) of the exemplary “tests” table of Table V include invalid data. However, it should be noted that identifying rows and tables in the underlying database(s) is merely illustrated by way of example. Other information can be gathered with respect to the invalid data. For instance, a column identifier of a column in a given database table having the invalid data, a user detecting the invalid data—e.g., by executing the underlying abstract query—and/or a date and time of detection of the invalid data can also be determined. Furthermore, a corresponding error condition can be registered with the marked invalid table. For instance, line 002 of Table IX may include an indication that the age value in the corresponding table row is negative. All such implementations are broadly contemplated. An exemplary marked invalid table is illustrated in FIG. 7.

In one embodiment, the received query result is modified at step 650 with respect to the invalid data included therewith, whereby a modified query result (e.g., modified query result 270 of FIG. 2) is generated. For instance, the invalid data can be marked up or removed from the query result. In one embodiment, the invalid data is highlighted or stroked through.

At step 660, the modified query result is output to a corresponding requesting entity (e.g., application(s) 240 of FIG. 2) for further processing. For instance, the modified query result is displayed to a user who issued the underlying abstract query or transmitted to a suitable analysis routine.

At step 670, a notification (e.g., notification 274 of FIG. 2) is sent to the user who issued the underlying abstract query and/or an administrator of the underlying database(s) and processing then exits. In one embodiment, the notification indicates that the query result contains the invalid data. In this case, the notification can be output together with the modified query result. Alternatively, no result set or an empty result set can be output. The notification may further indicate that the invalid data marked up in the modified query result is automatically removed from display in subsequent query executions. The notification can also be transmitted together with the marked invalid table requesting the user and/or administrator to take an appropriate action with respect to the database table(s) having the invalid data.

In one embodiment, sending the notification includes marking up the rows of the database tables that include the invalid data. For instance, the rows are associated with an “invalid” flag such that subsequent queries against the underlying database(s) can be modified in a manner preventing output of rows having an “invalid” flag. In one embodiment, the “invalid” flag are corresponding row identifiers included with the marked invalid table. Alternatively, the “invalid” flag is included with a separate column named “invalid” that is created in a given database table of the underlying database(s) when the invalid data is encountered and that has a value “Yes” for each row identified in the marked invalid table. Furthermore, storage of the modified query result having the marked up invalid data or execution of an analysis routine thereon can be disabled. All such implementations are broadly contemplated.

Furthermore, as was noted above, the query result received at step 610 can be returned from the underlying database(s) in response to execution of the underlying abstract query by a user. However, in one embodiment the abstract query is periodically executed by a suitable data cleansing unit (e.g., data cleansing unit 265 of FIG. 2) as a scheduled task configured for retrieval of invalid data in the underlying database(s). In other words, the abstract query is used to perform a periodic data cleansing operation on the data of the underlying database(s). Thus, when invalid data is identified in the underlying database(s), a corresponding notification and marked invalid table are generated and issued to an administrator of the underlying database(s). The administrator may then perform an appropriate cleaning operation on the invalid data.

Referring now to FIG. 7, an exemplary marked invalid table 700 (e.g., marked invalid table 272 of FIG. 2) is illustrated. The exemplary marked invalid table 700 illustratively includes a plurality of rows 710, 720, 730 and 740, and a plurality of columns 750, 760, 770, 780 and 790.

Columns 750 and 760 are used to uniquely identify rows in underlying database tables having identified invalid data (e.g., invalid data 284 of FIG. 2). More specifically, column 750 includes table identifiers and column 760 includes row identifiers.

As described above with reference to Table IX, the marked invalid table may include additional information concerning the identified invalid data. Illustratively, column 770 is configured to uniquely identify columns in the underlying database tables that include the identified invalid data in the corresponding identified rows. Column 780 is configured for storage of a date and time of detection of the invalid data in the identified database tables. Column 790 is merely shown to illustrate that further information, such as a user detecting the invalid data, can also be included with table 700.

Rows 710, 720 and 730 illustratively correspond to lines 002-004 of the exemplary marked invalid table of Table IX, whereto columns 770-790 were added. Furthermore, a plurality of rows 740 is shown to illustrate that table 700 can be stored persistently having entries that are created over a longer period of time. Accordingly, table 700 can be used as a log file for logging information related to detection of invalid data.

While the foregoing is directed to embodiments of the present invention, other and further embodiments of the invention may be devised without departing from the basic scope thereof, and the scope thereof is determined by the claims that follow.

What is claimed is:

1. A computer-implemented method of performing a clean operation on a query result, comprising:
receiving a query result for an abstract query composed on the basis of a data abstraction model, wherein the query result has result data for at least one logical result field included in the abstract query and wherein the query result is based on physical data from one or more databases and wherein the data abstraction model models the physical data in the one or more databases in a manner making a schema of the physical data transparent to a user of the abstraction model, the logical result field having a corresponding logical field definition in the abstraction model;
applying one or more value constraints specified in the logical field definition to determine whether the result data of the query result includes invalid data that does not satisfy the value constraints; and
if so, creating a data structure that uniquely identifies the invalid data.

2. The method of claim 1, further comprising:
if a data structure that uniquely identifies the invalid data is created, disabling further processing of the query result.

3. The method of claim 2, wherein disabling further processing of the query result comprises at least one of:
(i) disabling persistent storage of the query result; and
(ii) disabling execution of an analysis routine on the query result.

4. The method of claim 1, further comprising:
removing the invalid data from the query result on the basis of the created data structure.

5. The method of claim 1, further comprising:
marking up the invalid data in the query result prior to presenting the query result to a corresponding requesting entity, wherein the marking up visually identifies the invalid data as distinct from valid data included with the query result.

6. The method of claim 5, wherein marking up the invalid data includes at least one of (i) striking through, and (ii) highlighting the invalid data if the requesting entity is a user.

7. The method of claim 5, wherein marking up the invalid data includes associating one or more suitable indicators with the invalid data if the requesting entity is an analysis routine.

8. The method of claim 1, wherein the query result is obtained in response to execution of the abstract query against the one or more databases, the method further comprising:
issuing a notification to a requesting entity that issued the abstract query against the one or more databases indicating that presentation of the invalid data in result sets that are obtained in subsequent executions of the abstract query against the one or more databases is prevented.

9. The method of claim 8, further comprising:
associating a query condition with the abstract query that filters the invalid data from the result sets that are obtained in subsequent executions of the abstract query against the one or more databases on the basis of the created data structure.

10. The method of claim 1, wherein the query result is defined in tabular form having one or more data records including the result data; and wherein creating the data structure comprises:
identifying each data record and result field including the invalid data; and
identifying, on the basis of each identified data record and result field, at least each row in a corresponding table of the one or more databases that includes the invalid data.

11. The method of claim 10, wherein creating the data structure further comprises:
generating, in the data structure, a unique entry for each identified row of a corresponding table of the one or more databases to uniquely identify location of the invalid data in the one or more databases.

12. The method of claim 1, further comprising:
transmitting the created data structure to an administrator of the one or more databases to allow correction of the invalid data in the one or more databases.

13. A computer-readable medium containing a program which, when executed by a processor, performs a process for performing a clean operation on a query result, the process comprising:
receiving a query result for an abstract query composed on the basis of a data abstraction model, wherein the query result has result data for at least one logical result field included in the abstract query and wherein the query result is based on physical data from one or more databases and wherein the data abstraction model models the physical data in the one or more databases in a manner making a schema of the physical data transparent to a user of the abstraction model, the logical result field having a corresponding logical field definition in the abstraction model;
applying one or more value constraints specified in the logical field definition to determine whether the result data of the query result includes invalid data that does not satisfy the value constraints; and
if so, creating a data structure that uniquely identifies the invalid data.

14. The computer-readable medium of claim 13, wherein the process further comprises:
if a data structure that uniquely identifies the invalid data is created, disabling further processing of the query result.

15. The computer-readable medium of claim 14, wherein disabling further processing of the query result comprises at least one of:
(i) disabling persistent storage of the query result; and
(ii) disabling execution of an analysis routine on the query result.

16. The computer-readable medium of claim 13, wherein the process further comprises:
removing the invalid data from the query result on the basis of the created data structure.

17. The computer-readable medium of claim 13, wherein the process further comprises:
marking up the invalid data in the query result prior to presenting the query result to a corresponding requesting entity, wherein the marking up visually identifies the invalid data as distinct from valid data included with the query result.

18. The computer-readable medium of claim 17, wherein marking up the invalid data includes at least one of (i) striking through, and (ii) highlighting the invalid data if the requesting entity is a user.

19. The computer-readable medium of claim 17, wherein marking up the invalid data includes associating one or more suitable indicators with the invalid data if the requesting entity is an analysis routine.

20. The computer-readable medium of claim 13, wherein the query result is obtained in response to execution of the abstract query against the one or more databases, and wherein the process further comprises:
issuing a notification to a requesting entity that issued the abstract query against the one or more databases indicating that presentation of the invalid data in result sets that are obtained in subsequent executions of the abstract query against the one or more databases is prevented.

21. The computer-readable medium of claim 20, wherein the process further comprises:
associating a query condition with the abstract query that filters the invalid data from the result sets that are obtained in subsequent executions of the abstract query against the one or more databases on the basis of the created data structure.

22. The computer-readable medium of claim 13, wherein the query result is defined in tabular form having one or more data records including the result data; and
wherein creating the data structure comprises:
identifying each data record and result field including the invalid data; and
identifying, on the basis of each identified data record and result field, at least each row in a corresponding table of the one or more databases that includes the invalid data.

23. The computer-readable medium of claim 22, wherein creating the data structure further comprises:
generating, in the data structure, a unique entry for each identified row of a corresponding table of the one or more databases to uniquely identify location of the invalid data in the one or more databases.

24. The computer-readable medium of claim 13, wherein the process further comprises:
transmitting the created data structure to an administrator of the one or more databases to allow correction of the invalid data in the one or more databases.
